(19) United States
(12) Patent Application Publication
(10) Pub. No.: US 2021/0316982 A1
(43) Pub. Date: Oct. 14, 2021

(54) MACHINE AND METHOD TO SELECT AND DISPENSE BEVERAGES

(71) Applicant: De' Longhi Appliances S.r.l. con Unico Socio, Treviso (IT)

(72) Inventor: Amedeo Pierfrancesco COMARELLA, Treviso (IT)

(21) Appl. No.: 17/270,930

(22) PCT Filed: Aug. 28, 2019
(86) PCT No.: PCT/IT2019/050192

§ 371 Date: Feb. 24, 2021

(30) Foreign Application Priority Data
Aug. 29, 2018 (IT) 102018000008230

(51) Int. Cl. B67D 1/08; A47J 31/52; G07F 9/02; G07F 13/06; G05B 19/4155

(52) U.S. Cl. CPC B67D 1/0888; A47J 31/525; G05B 2219/2645; G07F 13/065; G05B 19/4155; G07F 9/023

(57) ABSTRACT

A machine to select and dispense beverages is provided with a user interface, including a touch-type display screen, and by means of which a user can select a type of beverage to be dispensed. The user interface includes at least a first display screenshot including a plurality of sub-windows each associated with a determinate type of beverage which can be selected by the user, and a plurality of second configuration screenshots, each associated with a sub-window and including one or more parameters and/or characteristics modifiable by the user and correlated to the type of beverage associated with the respective sub-window.

### FIELD OF THE INVENTION

The present invention concerns a machine and a method to select and dispense beverages, such as for example hot beverages such as coffee, tea, infusions, hot chocolate, cocoa, milk, or cold beverages, such as fruit juices, or other, which can be supplied individually, or integrated with other substances according to the specific needs or preferences of the user.

The present invention concerns in particular a machine and a method to select and dispense beverages which, on the one hand, provide a user with a wide choice of types of beverages, and possibly a wide range of options to modify one or more parameters to personalize the chosen beverage, and on the other hand is extremely easy for a user to use and offers speed in the selection and dispensing of the desired beverage.

The present invention is applied, in particular, although not exclusively, to the typical coffee machines, or for similar beverages as indicated above, of the domestic or semi-professional type, for example for homes, communities, offices, schools, factories, where users can be a family unit or a community that meets for specific periods of time.

In particular, the aim of the present invention is to combine on the one hand a wide range of choice and variability of ingredients, doses, formats or other, with on the other hand making the choice extremely easy and intuitive, particularly if recurrent and repeated over the course of days.

### BACKGROUND OF THE INVENTION

Machines to select and dispense beverages are known which comprise a user interface by means of which a user can first select and then modify one or more characteristics of a beverage he/she wishes to consume.

Typically, since users want a beverage that can satisfy their personal taste, and therefore which depends on individual preferences, it is necessary for the machine to offer a certain degree of personalization of the beverage, such as to correspond to the specific characteristics required by the user. In this regard, the user interface normally allows to select a type of beverage, and to configure its composition by modifying one or more parameters such as for example the quantity to be dispensed, the addition of additional substances, the number of beverages to prepare, or more.

In recent years, with the spread of display screens and of touch-type technology, the substantially unlimited increase in the number of choices and options that are made available to the user by means of the user interface has been progressively made possible.

In order to provide a wide range of choices, in these types of touch screens a plurality of windows are generally displayed in succession one after the other, on command or also automatically, and depending on the different selections made; each of these windows allows to modify one or more parameters in order to obtain a beverage that has the desired characteristics before starting the dispensing of the desired beverage.

One disadvantage of the apparatuses and methods of the state of the art is that the possibility of making available a wide choice of options for each selection and dispensing of a beverage can be inconvenient, or even annoying, for a user who has to therefore continuously configure these parameters, especially in the event a beverage is ordered several times, before being able to send the dispensing command.

Moreover, in known apparatuses searching for the desired beverage by means of the user interface may not be immediate and intuitive, especially if the apparatus offers a vast quantity of selectable products.

A further disadvantage of known types of apparatuses is that, in order to prepare a beverage that corresponds to the specific requirements of the user, the user interface requires the completion of laborious set up, configuration or confirmation screenshots.

This is even more problematic if the apparatus is used in communities where the time slot during which the apparatus is used is the same for many users, creating waiting times and repeated contacts with the touch screen, which are even potentially damaging, in the long run, for the correct functionality of the apparatus itself.

The video posted on the Internet at the URL address: https://www.youtube.com/vvatch?v=NtEdZcAHqHA shows a machine to dispense beverages provided with a user interface comprising a touch-sensitive display screen, on which a plurality of data can be displayed, including a plurality of beverages to be selected. Although this machine allows a wide selection of organoleptic characteristics and sizes of a beverage to be prepared, it provides different icons and commands in order to respectively select a beverage, modify its organoleptic characteristics and dispense the selected beverage, therefore the user has to provide at least two distinct commands. Furthermore, when the display screen is not in a condition of use, it is necessary to select at least one additional icon or command in order to display the types of beverages available.

Document US-A-2014/0188271 describes a machine to dispense beverages provided with a user interface on a touch-sensitive screen, which comprises a plurality of screenshots selectable by a user, including at least one advertising screenshot, a beverage selection screenshot, and a screenshot to select the characteristics and/or the quantities of the beverage selected and start its dispensing. Also in this case, the user has to necessarily provide at least a first command to select a beverage and a second dispensing command.

Also from US-A-2013/037565 a machine to dispense beverages is known which provides a screen by means of which it is possible to receive selections and commands from the user. In particular, once the user has selected a certain type of beverage with a first command, the memorized preferences of the user can be displayed on the screen in order to determine one or more parameters for the beverage selected.

US-A-2015/027316 refers to a machine to prepare beverages comprising an interface provided with a touch-sensitive screen on which different groups of icons can be displayed, including a cup icon, which is related to a function of setting the parameters for the preparation of the beverage, therefore requiring further commands.

US-A-2010/0193537 describes a vending machine for food products, or non-food products, which may or may not be packaged, which comprises a screen that displays information correlated to different products available as a function of the operative status of the machine, of the position of the machine or possibly of the date and time of day. This solution, moreover, provides to display the products available as virtual buttons, whose disposition is modified as a function of a plurality of parameters, complicating the choice for the user. Application WO-A_2017/192871 describes a machine to dispense beverages which provides to display on the touch-sensitive screen distinct and dedicated buttons to, respectively, select and dispense the beverage.

US-A-2016/0090288 describes a machine to dispense beverages, in particular suitable to prepare cocktails.

None of the machines described in the documents above provides a “one-touch” function by means of which a user can provide a single command to select a beverage and start its preparation/dispensing.

There is therefore the need to perfect a method and an apparatus to select and dispense beverages which can overcome at least one of the disadvantages of the state of the art.

One purpose of the present invention is therefore to provide an apparatus to select and dispense beverages which is easy and intuitive to use and which, while providing a user with a wide choice both of type of beverages and also of options to personalize each type of beverage, also allows to make a quick, fast and intuitive selection of the beverage chosen.

In particular, one purpose of the present invention is to provide an apparatus to select and dispense beverages which allows a user to start the dispensing of a desired beverage with a single command.

It is also a purpose of the present invention to provide an apparatus to dispense beverages which implements a user interface that is clear, clean and intuitive for a user, so-called “user-friendly”, that is, that is able to adapt to the user's preferences, unlike known solutions where it is the user who has to adapt and conform to the user interface itself, possibly having to resort to manuals or instruction screens.

Another purpose of the present invention is to perfect a method to select and dispense beverages that can offer the user a convenient and functional solution for personalizing a beverage chosen in the desired manner and which can at the same time facilitate and simplify the dispensing of the beverage itself.

Furthermore, it is also a purpose of the present invention to develop a method to dispense beverages that is rapid and quick, or more precisely, that is not as complicated and cumbersome as that of known solutions.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

Embodiments described here concern a machine to select and dispense beverages provided with a user interface by means of which a user can choose a specific beverage to be dispensed.

According to some embodiments, the user interface comprises a touch-type display screen.

According to some embodiments, the user interface comprises at least a first display screenshot comprising a plurality of sub-windows, each correlated to a determinate type of beverage.

According to some embodiments, each sub-window comprises at least a first icon and a second icon selectable by a user.

According to some embodiments, the selection of the first icon can entail the generation of a command signal configured to cause a direct dispensing of the beverage chosen, so as to provide an easy and quick “one touch” selection for the user, without the need to provide additional commands to obtain the desired beverage.

In other words, a single touch, or selection of the first icon can entail both the generation of a signal to select a beverage, and also a signal to start the preparation and the dispensing of the beverage chosen.

According to some embodiments, the selection of the second icon can entail the selection of the type of beverage represented in the first icon, and the display of a second display screenshot associated with the beverage selected in order to allow the user to set and/or modify one or more parameters and/or characteristics correlated to the type of beverage chosen, before commanding the dispensing thereof.

In other words, a selection of the second icon entails generating a signal to select the beverage, and the display of the respective display screenshot.

By way of example, the parameters, as a function of the type and/or beverage chosen, can comprise one or more of either the quantity of beverage, quantity of sugar, quantity of froth, aroma, format, intensity of the taste, temperature, infusion time, or more.

According to some embodiments, the machine comprises a control and command unit, connected to the user interface and configured to control and command the functioning of the machine in order to dispense on each occasion the beverage chosen and selected by the user as a function of the command or selected received by means of the user interface.

According to further embodiments, the control and command unit comprises a 1.0 memorization unit configured to memorize the choices and selections made by one or more users.

According to some embodiments, the control and command unit comprises a processing unit configured to process the data received from the user interface and memorized in the memorization unit, in order to verify which types of beverages are chosen most frequently, and possibly calculate a preference index for each of them.

According to further variants, the processing unit can also consider one or more parameters and/or characteristics associated with the types of preferred beverages.

According to some embodiments, the control and command unit can command the user interface in order to display the sub-windows associated with the respective types of beverage in the first display screenshot, ordered one after the other on the basis of the preference index calculated.

In this way, the sub-windows associated with the types of beverages that are chosen with greater preference are directly visible in the first display screenshot, allowing the user to simply and quickly select his/her favorite beverages with a single command to select the respective first icon.

According to some embodiments, the processing unit can be configured to define a specific preference index for each user, for example identified on each occasion by means of a suitable recognition device, such as for example a key, or a magnetic card, a QR code, a barcode, or other.

According to other embodiments, the processing unit can be configured to define a general preference index relating to a group of users.

Embodiments described here also concern a method to select and dispense beverages in a machine to select beverages provided with a user interface comprising a touch screen display screen.

The method according to the invention provides to choose a type of beverage on the first display screenshot comprising a plurality of sub-windows, each associated with a determinate type of beverage to be dispensed and frame on the display screen the sub-window associated with the type of beverage chosen, wherein the sub-window comprises at least a first icon and a second icon.

In the event that no modification of the parameters and/or of the characteristics of the beverage is required, the method according to the invention provides to select the first icon to directly dispense the beverage chosen.

In the event that a modification of at least one of the parameters and/or of the characteristics of the beverage chosen is required, the method provides to select the second icon in order to display a second configuration screenshot, in which one or more parameters correlated to the type of beverage chosen are displayed, and to modify one or more parameters and/or characteristics correlated to the type of beverage chosen, before providing a dispensing command in order to dispense the beverage.

According to some embodiments, in order to choose the type of beverage, the selection and dispensing method provides to search for the respective sub-window in the first display screenshot by means of scrolling commands.

According to further embodiments, the selection and dispensing method provides to memorize data relating at least to the types of beverages chosen by one or more users, calculate for each a preference index on the basis of the frequency with which they are chosen, and display them on the first display screenshot with the respective sub-windows ordered one after the other on the basis of the preference index calculated.

In this way, for each new beverage selection and dispensing operation, the user will be presented first with the sub-windows relating to his/her favorite beverages, so as to make their selection simpler and faster.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a schematic view of the components of a machine to select and dispense beverages according to embodiments described here;

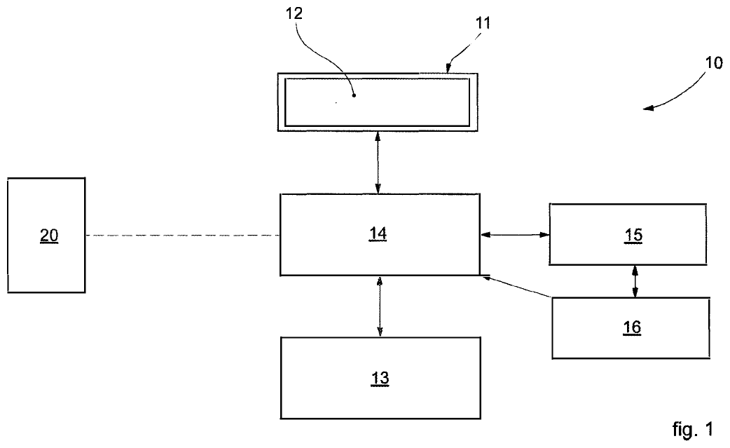

FIG. 2 is a schematic view of a possible interaction interface according to embodiments described here;

FIG. 3 is a block diagram of a method to select and dispense a beverage according to embodiments described here.

### DETAILED DESCRIPTION OF SOME EMBODIMENTS

We will now refer in detail to the various embodiments of the present invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Embodiments described here concern a machine 10 to select and dispense beverages, such as for example a machine to prepare hot beverages such as coffee, tea, infusions, hot chocolate, cocoa, milk, or cold beverages such as fruit juices or other, which can be supplied individually, or integrated with other substances depending on the specific needs or preferences of the user.

The machine 10 can be a machine of the domestic or semi-professional type, suitable to dispense a plurality of types of beverages with characteristics that can be personalized by a user according to his/her own tastes.

According to some embodiments, the machine 10 comprises a user interface 11 configured to allow a user to choose a beverage to be dispensed, and to command its dispensing.

According to some embodiments, the user interface 11 comprises a GUI (Graphical User Interface).

According to some embodiments, the user interface 11 comprises a display screen 12 configured to show the user the various choice options, and the various screenshots of the user interface 11.

According to some embodiments, the display screen 12 is a touch screen which directly integrates the command means.

In accordance with some embodiments, by means of the user interface 11 the user can also set and/or modify one or more parameters and/or characteristics of the beverage chosen in order to personalize it according to his/her own tastes.

The commands that the user can provide can refer to the selection of a general beverage, or the selection of a beverage having a specific and well-defined composition chosen according to his/her personal taste.

For example, in the case of a coffee machine 10, the commands provided by the user can be aimed at selecting an espresso coffee, a concentrated espresso coffee, a diluted espresso coffee, an American coffee, or in general a beverage having a determinate composition defined by a plurality of parameters and characteristics.

By way of example, the parameters and/or characteristics that can be modified by the user, as a function of the type of beverage chosen, can comprise one or more of either the quantity of beverage, the quantity of sugar, the quantity of froth, aroma, intensity of taste, temperature, infusion time, or more.

For example, in the case of a coffee beverage, the parameters can refer to one or more of either the quantity of milk, sugar, or froth, the type of aroma, or more. In the case of a tea beverage, for example, the parameters can refer to one or more of either the quantity of sugar, the type of tea, infusion time or temperature, possible addition of milk, or more.

According to some embodiments, the machine 10 also comprises a composition and dispensing device 13 configured to dispense on each occasion the beverage chosen by the user.

According to some embodiments, the machine also comprises a control and command unit 14 connected to the user interface 11 and configured to control the functioning of the machine 10 itself and command the composition and dispensing device 13 as a function of the commands received by means of the user interface 11.

According to some embodiments, based on the selection made by the user, the control and command unit 14 sends commands to the composition and dispensing device 13 so as to modify the composition of the beverage according to the preferences set by the user.

The composition and dispensing device 13 can be provided with a plurality of preparation elements, not shown, which participate in the preparation of one or more types of beverages. By way of example only, again referring to a coffee machine, the preparation elements can refer to the coffee grinder, the boiler, the electric pump, the water pressure system, the dispensing unit or other. These preparation elements can be controlled directly by the control and command unit 14.

According to some embodiments, the control and command unit 14, based on the selections made by the user, can generate a computer program code comprising a series of instructions relating to the composition of the beverage selected by the user and transmit them to the composition and dispensing device 13, which can be configured to interpret these instructions and suitably control its preparation elements in order to make the beverage selected by the user.

According to further embodiments, the control and command unit 14 is connected to, or comprises, a memorization unit 15 configured to memorize the choices and selections made by one or more users.

According to some embodiments, the control and command unit 14 is connected to, or comprises, a processing unit 16 configured to process the data received by means of the user interface 11 and memorized in the memorization unit 15, in order to verify which types of beverages are chosen more frequently, and possibly calculate an index of preference thereof.

According to further variants, the processing unit 16 can also consider and process one or more parameters and/or characteristics associated with the types of beverages preferred.

According to some embodiments, the user interface 11 is configured on the one hand to allow a user, if he/she wishes, an accurate and detailed personalization of the parameters and/or characteristics of the beverage chosen, and on the other hand to also allow a direct dispensing thereof with the insertion of a single command, in the event the user does not require a particular composition.

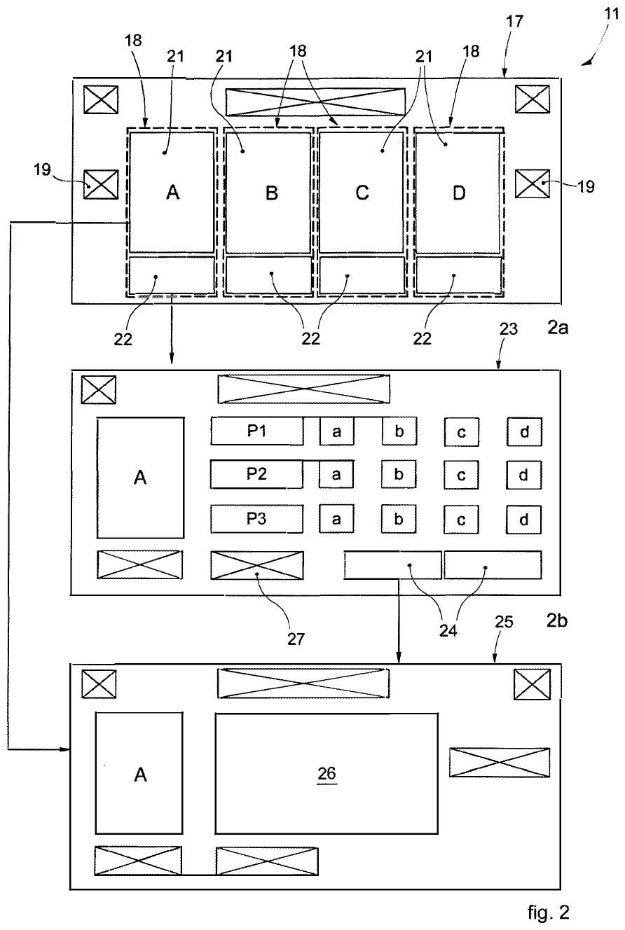

According to some embodiments, for example described with reference to FIG. 2, the user interface 11 comprises a first display screenshot 17 provided with a plurality of sub-windows 18, each associated with a determinate type of beverage selectable by the user (FIG. 2a).

According to some embodiments, the first display screenshot 17 can comprise scrolling commands 19 configured to allow the sub-windows 18 to scroll in order to frame the one corresponding to the type of beverage desired in the display screen 12.

By way of example, the first display screenshot 17 can comprise a variable number of types of beverages, and therefore of sub-windows 18, for example 5, 10, 15, 20, 35, 50, or more, and only some of them can be displayed simultaneously on the display screen 12, while the others can be searched for and framed on each occasion by acting on the scrolling commands 19.

By way of example, FIG. 2a shows four sub-windows 18 associated with respective types of beverages A, B, C, D.

By way of example, the types of beverages can comprise espresso coffee, American coffee, diluted coffee, macchiato coffee, a “latte” coffee, cappuccino, decaffeinated coffee, ginseng extract, cold coffee, chocolate, one or more types of tea, infusions, hot water, fruit juices, milk, and more.

According to some embodiments, the types of beverages can comprise combinations of different types of beverage and/or of different size of the dose of beverage, for example beverages in a single dose, or in multiple doses.

By way of example only, the types of beverages can provide a single cup of espresso, a single cup of cappuccino, two cups of cappuccino, a mug of American coffee, and many other combinations of type and dose of beverage.

According to some embodiments, the sub-windows 18 can be disposed in succession one after the other and ordered on the basis of one or more criteria.

For example, according to some embodiments, the sub-windows 18 are ordered according to the frequency with which they are chosen by one or more users, so as to speed up the user's search and selection.

According to some embodiments, it can be provided that the control and command unit 14 commands the user interface 11 in order to display the sub-windows 18 on the basis of the calculated preference index.

According to some embodiments, the processing unit 16 can be configured to define a general preference index relating to a group of users.

According to other embodiments, the preference index can be calculated for each individual user.

For example, it can be provided that each user is provided with a recognition device 20 by means of which he/she can be recognized and identified by the control and command unit 14 of the machine 10, for example by means of the user interface 11 or with other means to transmit and communicate data.

According to some embodiments, the recognition device 20 associated with the user can be, for example, a key, or a magnetic card, a QR code, a bar code, a software application on a smartphone, or suchlike, provided with a unique identification code and communication means suitable to communicate with the control and command unit 14.

According to some embodiments, the processing unit 16 can be configured to create and manage one or more profiles each associated with a single user, or possibly a group of users, and each provided with its own identification code.

According to these embodiments, the processing unit 16 can be configured to determine a different display of the sub-windows 18 on the first display screenshot 17 as a function of the profile associated with the identification code identified.

According to some embodiments, the processing unit 16 can be configured to define a specific preference index for each user who is identified on each occasion by means of his/her own unique code, and to order the sub-windows 18 in a way that is personalized for the individual user.

According to some embodiments, the processing unit 16 can also be configured to create new sub-windows 18 correlated to the combinations of type of beverage and parameters preferred by the individual user or by the group of users. According to some embodiments, it can be provided that the processing unit 16 is configured to implement a computer program based on a neural network, designed to learn the user's choices and identify his/her favorite beverages, as well as to suggest new beverages with compositions in accordance with his/her personal tastes.

According to possible solutions, the processing unit 16 can be configured to save the composition of the beverage set in the memorization unit 15, for example in a part dedicated to memorizing one or more beverage compositions. These saved compositions can be subsequently re-suggested in the first display screenshot 17, for example among the types of favorite beverages, to allow the user to find them quickly.

According to some embodiments, each sub-window 18 comprises a first icon 21 selectable by a user to command the direct dispensing of the beverage associated with the sub-window 18.

The first icon 21 acts both as a selection command, and also as a dispensing command, determining the direct start of the preparation of the beverage associated with the respective sub-window 18, and thus allowing an easy and quick “one touch” selection for the user, without the need to provide additional commands.

By way of example, the first icon 21 can comprise an image or words, or a combination of both, which are explanatory of a determinate type of beverage and easily recognizable and identifiable by a user.

According to some embodiments, each sub-window 18 also comprises a second icon 22 selectable by a user to command the display of a second configuration screenshot 23.

By way of example, the second icon 22 can show a symbol, a word, or an image that suggests to the user the possibility to personalize the beverage chosen.

According to some embodiments, this second icon 22 therefore acts only as a command to select a type of beverage.

Following the selection of the second icon 22, the control and command unit 14 commands the display screen 12 to replace the first display screenshot 17 with the second configuration screenshot 23.

According to some embodiments, the user interface 11 comprises a plurality of second configuration screenshots 23, each associated with a sub-window 18.

According to some embodiments, for example described with reference to FIG. 2b, the/each configuration screenshot 23 comprises one or more parameters and/or characteristics P1, P2, P3 modifiable by the user and correlated to the type of beverage associated with the respective sub-window 18.

According to some embodiments, for each parameter and/or characteristic P1, P2, P3 one or more modification commands a, b, c, d can be provided to modify and/or select the quantity, type, or level desired for each parameter and define the desired composition.

According to possible solutions, the/each configuration screenshot 23 can comprise one or more scrolling commands 27 configured to allow the scrolling of parameters P1, P2, P3, in order to display others on the display screen 12, for example parameters P4, P5, P6, or others, not directly visible.

According to further embodiments, the/each configuration screenshot 23 comprises at least one start command 24 selectable by the user to command the dispensing of the beverage according to the composition selected by the user.

According to some embodiments, two or more start commands 24 can be provided, each configured to command the preparation of a certain number of selected beverages.

For example, two start commands 24 can be provided, one to command the preparation and dispensing of a single beverage according to the composition selected, and the other to command the preparation and dispensing of two beverages according to the composition selected.

In the event the user wishes to modify the parameters and/or characteristics of the beverage, it is therefore necessary that he/she provides at least a first command to select the beverage by means of the second icon 22, one or more modification commands to define the composition, and finally a dispensing command by means of the start command 24 in order to start the preparation and dispensing of the beverage selected.

According to some embodiments, the user interface 11 comprises a third preparation screenshot 25, configured to make the state of progress of the preparation of the beverage selected visible to a user.

The third preparation screenshot 25 can comprise, for example, a graph 26 which shows the progressive state of progress of the preparation of the beverage.

According to some embodiments, the control and command unit 14 can command the display screen 12 in order to show the third preparation screenshot 25 when the first icon 21 or the start command 24 are selected.

At the end of the preparation and dispensing of the beverage, the control and command unit 14 can command the display screen 12 so as to make the first display screenshot 17 available again to the user.

Embodiments described here also concern a method to select and dispense a beverage in a machine 10 provided with a user interface 11 comprising a touch screen display screen 12.

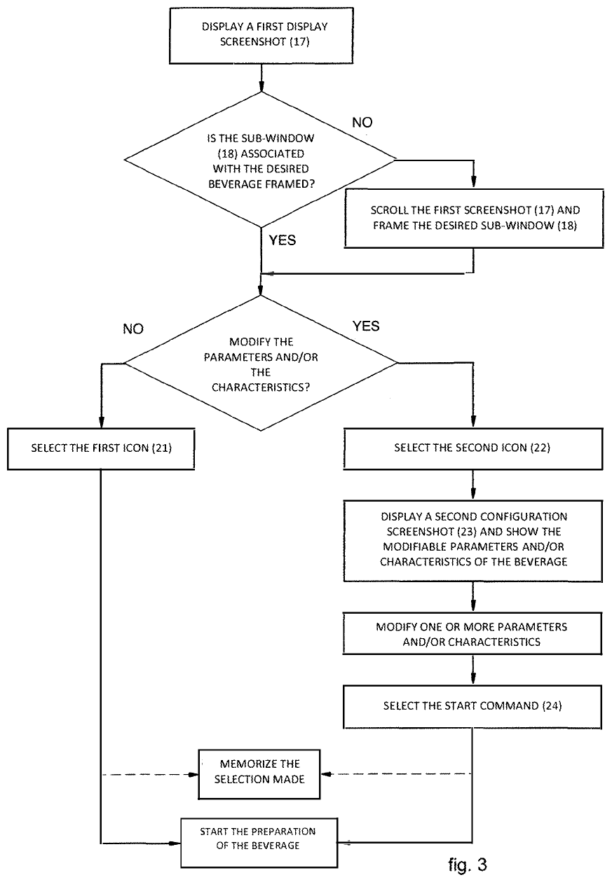

FIG. 3 shows by way of example a block diagram of the selection and dispensing method according to embodiments described here.

The method initially provides to make available a first display screenshot 17 and to frame a sub-window 18 associated with the type of beverage desired in the display screen 12.

In the event that the desired sub-window 18 is not already framed in the display screen 12, the method can provide to scroll the first display screenshot 17 by means of scrolling commands 19 until it is framed.

Subsequently, in the event that no modification of the parameters and/or characteristics of the beverage is required, the method provides to select the first icon 21 to directly dispense the beverage chosen.

In the event that a modification of at least one of the parameters and/or characteristics of the beverage is required, the method provides to select the second icon and display the second configuration screenshot 23 on the display screen 12.

According to some embodiments, the method can therefore provide to modify one or more parameters and/or characteristics within the type of beverage previously selected, and finally select the start command 24 to start the preparation and dispensing of the beverage.

According to some embodiments, the selection and dispensing method can also provide to memorize the selection made by the user and process the memorized data.

According to further embodiments, the method can provide to display a third preparation screenshot 25 during the preparation of the beverage, in order to show the user the state of progress of the desired beverage.

According to further embodiments, at the end of the dispensing of the beverage, the method can provide to again display the first display screenshot 17 on the display screen 12.

According to further embodiments, the method provides to calculate the respective preference index for each beverage selection and dispensing operation, and to suitably update on each occasion the order of the sub-windows 18 associated with the types of beverages.

According to some embodiments, the method can provide to create a plurality of profiles each associated with a single user, or possibly a group of users, and each provided with its own identification code, and to provide a different display order of the sub-windows 18 on the first display screenshot 17 as a function of the profile associated with the identification code recognized on each occasion.

It is clear that modifications and/or additions of parts may be made to the machine 10 and to the method to select and dispense beverages as described heretofore, without departing from the field and scope of the present invention.

According to further embodiments, for example, the user interface 11 can comprise other screenshots by means of which the user can set, for example, the operative parameters of the machine, or the characteristics of the ingredients used.

For example, one or more of either a screenshot suitable to select a determinate type of coffee beans, and possibly modify the grain size, or the grinding level, a screenshot configured to display and/or modify the hardness of the water used, a screenshot configured to display the selection and/or execution of a rinsing or descaling operation, or others, can be provided.

It is also clear that, although the present invention has been described with reference to some specific examples, a person of skill in the art shall certainly be able to achieve many other equivalent forms of machine 10 and method to select and dispense beverages, having the characteristics as set forth in the claims and hence all coming within the field of protection defined thereby.

1. Machine to select and dispense beverages provided with a user interface (11), comprising a touch-type display screen (12), and by means of which a user can select a type of beverage to be dispensed, wherein said user interface (11) comprises at least a first display screenshot (17) comprising a plurality of sub-windows (18) each associated with a determinate type of beverage which can be selected by the user, and a plurality of second configuration screenshots (23), each associated with a sub-window (18) and comprising one or more parameters and/or characteristics modifiable by the user and correlated to the type of beverage associated with the respective sub-window (18),
wherein each sub-window (18) comprises at least a first icon (21) selectable by a user and configured to function, as a function of a single touch by the user, both as a command to select the beverage associated with the respective sub-window (18), and also as a command for the dispensing, determining the direct start of the preparation and dispensing of said selected beverage associated with the sub-window (18), and at least a second icon (22) selectable by a user and configured to select the beverage associated with said sub-window (18) and command the display on said display screen (12) of a second configuration screenshot (23) associated with said beverage selected.

2. Machine as in claim 1, wherein it comprises a control and command unit (14), connected to said user interface (11) and configured to control and command the functioning of the machine to dispense on each occasion the beverage chosen and selected by the user as a function of the command or commands received by means of said user interface (11).

3. Machine as in claim 2, wherein said control and command unit (14) is connected to, or comprises a, memorization unit (15) configured to memorize the choices and selections made by one or more users, and a processing unit (16) configured to process the data received from said user interface (11) and memorized in said memorization unit (15), in order to verify which types of beverages are chosen most frequently, and calculate a preference index for each of them.

4. Machine as in claim 3, wherein said control and command unit (14) is configured to command said display screen (12) and said user interface (11) in order to display the sub-windows (18) associated with the respective types of beverage in said first display screenshot (17), ordered one after the other on the basis of the preference index calculated.

5. Machine as in claim 3, wherein said processing unit (16) is configured to define a specific preference index for each user identified on each occasion by means of a recognition device (20), and/or for a group of users.

6. Machine as in claim 1, wherein, each configuration screenshot (23) comprises one or more parameters and/or characteristics (P1, P2, P3) modifiable by the user and correlated to the type of beverage associated with the respective sub-window (18) and at least a start command (24) selectable by the user in order to command the dispensing of the beverage according to the composition selected.

7. Machine as in claim 1, wherein said user interface (11) comprises a third preparation screenshot (25), configured to make visible for a user the state of progress of the preparation of the beverage selected and activatable as a function of the selection of said first icon (21) or of a start command (24) provided in the respective configuration screenshot (23).

8. Method to select and dispense beverages in a beverage selection and dispensing machine (10) provided with a user interface (11) comprising a touch-type display screen (12), wherein said method comprises:
displaying a first display screenshot (17) comprising a plurality of sub-windows (18), each associated with a determinate type of beverage, and framing on said display screen (12) the sub-window (18) associated with a type of beverage to be dispensed, wherein said sub-window (18) comprises at least a first icon (21) and a second icon (22), wherein
in the event that no modification is required of the parameters and/or characteristics of the beverage associated with said sub-window (18) framed, said method provides to select said first icon (21) to provide with a single touch both a command to select the beverage associated with the respective sub-window (18), and also a command for the dispensing thereof, determining the direct start of the preparation and dispensing of said beverage selected; and
in the event that a modification is required of at least one of said parameters and/or characteristics of the beverage associated with said sub-window (18) framed, said method provides to select said second icon (22) in order to select the beverage associated with said sub-window (18) and display on said display screen (12) a second configuration screenshot (23) in which one or more parameters correlated to said selected beverage are displayed in order to modify one or more of said parameters and/or characteristics before providing a start command (24) to command the preparation and dispensing of said beverage selected.

9. Method as in claim 8, wherein, in order to frame said sub-window (18) associated with said beverage to be dispensed, it provides to slide said first display screenshot (17) by means of scrolling commands (19).

10. Method as in claim 8, wherein at the end of the dispensing of said beverage selected it provides to command said display screen (12) in order to again make said first display screenshot (17) available to the user.

11. Method as in claim 8, wherein it provides to memorize in a memorization unit (15) data relating to the selections made by a user and/or by a group of users in relation to the type of beverage, and/or to the specific composition of the beverage selected, defined by one or more parameters and/or characteristics.

12. Method as in claim 11, wherein it provides to process the data memorized and to calculate for each type of beverage and/or for each beverage composition a preference index on the basis of the frequency with which they are selected, and to order the respective sub-windows (18) in said first display screenshot (17) on the basis of said preference index calculated.

13. Method as in claim 8, wherein it provides to create a plurality of profiles each associated with a single user, or possibly with a group of users, and each provided with its own identification code, and to provide a different display order of said sub-windows (18) on said first display screenshot (17) as a function of the profile associated with the identification code recognized on each occasion.

14. Method as in claim 8, wherein it provides to create new sub-windows (18) correlated to the combinations of beverage type and parameters preferred by the individual user or by the group of users, and to make them available in said first display screenshot (17).
